(19) United States
(12) Patent Application Publication
(10) Pub. No.: US 2012/0118400 A1
(43) Pub. Date: May 17, 2012

(54) LEADING EDGE STRUCTURE, IN PARTICULAR FOR THE AIR INTAKE OF THE NACELLE OF AN AIRCRAFT ENGINE

(75) Inventors: Florent Bouillon, Anglesqueville (FR); Frederic Ravailler, Octeville sur Mer (FR)

(73) Assignee: AIRCELLE, Gonfreville l'Orcher (FR)

(21) Appl. No.: 13/383,651

(22) PCT Filed: Jun. 29, 2010
(86) PCT No.: PCT/FR2010/051366

§ 371 Date: Jan. 12, 2012

(30) Foreign Application Priority Data
Jul. 17, 2009 (FR) 09/03520

(51) Int. Cl. F02K 99/00

(52) U.S. Cl. 137/15.1

(57) ABSTRACT

The invention relates to a structure of a leading edge (1), in particular for the air intake of an aircraft nacelle, including a leading edge (2) and an inner partition wall (3) defining a longitudinal compartment (5) inside the leading edge (2). The leading edge (2) and said inner partition wall (3) are made of multiaxial composite materials.

### TECHNICAL FIELD

The present invention relates to a leading edge structure, in particular for the air intake of the nacelle of an aircraft engine.

### BRIEF DISCUSSION OF RELATED ART

As is known in itself, an aircraft engine nacelle forms the fairing of that engine, and it has multiple functions: this nacelle in particular includes, in its upstream portion, a portion commonly called the “air intake,” which has a generally cylindrical shape, and the role of which is in particular to channel the outside air toward the engine.

As shown in FIG. 1, appended hereto, where we have diagrammatically illustrated half of one such air intake in longitudinal cross-section, this nacelle portion includes, in its upstream zone, a leading edge structure 1 comprising a leading edge 2 on the one hand strictly speaking, commonly called “air intake lip,” and on the other hand a first inner partition wall 3 defining a compartment 5 in which deicing means 6 are generally positioned.

The air intake lip 2 is fixed by riveting to the downstream portion 7 of the air intake, said downstream portion having, on its outer surface, a protective cowl 9, and on its inner surface, sound absorption means 11 commonly called “acoustic shroud”; this downstream portion 7 of the air intake defines a sort of box closed by a second partition wall 13.

As a general rule, all of these parts are formed from metal alloys, typically aluminum-based for the air intake lip 2 and the protective cowl 9, and titanium-based for the two partition walls 3 and 13. The cowl 9 can also be made from a composite material.

Such a traditional air intake lip has a certain number of drawbacks: its weight is relatively high, its construction requires many assembly operations, and the presence of many rivets affects its aerodynamic qualities.

To eliminate these drawbacks, considerable research has been done in order to use composite materials, in particular for the leading edge structure 1.

However, to date this research has essentially come up against strength problems inherent to the use of composites: this strength has in fact been shown to be insufficient in particular in case of maintenance tool impacts (commonly called “service impacts,” impact energy in the vicinity of 50 Joules), birds (according to standard CS 25.631: mass of about 1.82 kg (4 pounds) striking the structure at about 350 knots) and hail.

The tests performed with composites have also revealed significant delamination and separation of the different layers forming those composites.

### BRIEF SUMMARY

The present invention therefore aims to provide a solution making it possible to use composite materials for aircraft leading edge structures, in particular for nacelles, that does not have the drawbacks of the prior art.

This aim of the invention is achieved with a leading edge structure, in particular for an aircraft nacelle air intake, comprising a leading edge and an inner partition wall defining a longitudinal compartment within said leading edge, remarkable in that said leading edge and said inner partition wall are formed from multiaxial composite materials.

A multiaxial composite structure is a stratified composite, i.e. comprising a plurality of one-dimensional plies (UD—fibers extending in a single direction) and/or bi-dimensional plies (2D—fibers extending in two directions), connected to one another by fibers passing through their thickness.

The use of such multiaxial composites to form a leading edge structure gives the latter excellent resistance relative to the different impacts it may undergo, and also makes it possible to do away from all of the delamination and separation problems observed in the state of the art.

According to other optional features of the leading edge structure according to the invention:

said leading edge is structural and made from a multiaxial monolithic composite material, and said inner partition wall is structural and made from a multiaxial monolithic composite material: “structural” means that the concerned element is “bearing,” i.e. it is sized to impart rigidity and the necessary strength to the assembly; “non-structural” means that the concerned element is not intended to provide that rigidity and strength, but it is on the other hand adapted to perform other functions (aerodynamic, protection, partition walls . . .); “monolithic” means that the different plies (i.e. the layers comprising each of the fibers embedded in the resin) forming the composite material are adhered to one another, without the interposition of a core between said plies;

the leading edge is structural and made from a multiaxial monolithic composite material, and said inner partition wall is structural and made from a multiaxial sandwich composite material: “sandwich” means that one (or more) core (for example formed by a honeycomb structure or foam) is sandwiched between plies or groups of plies;

the leading edge is structural and made from a multiaxial composite sandwich material, and said inner partition wall is structural and made from a multiaxial monolithic composite material;

the leading edge is structural and made from a multiaxial sandwich composite material, and said inner partition wall is structural and made from a multiaxial sandwich composite material;

the leading edge is structural and made from a multiaxial sandwich composite material, and said inner partition wall is non-structural and made from a multiaxial monolithic composite material;

the leading edge is structural and made from a multiaxial sandwich composite material, and said inner partition wall is non-structural and made from a multiaxial sandwich composite material.

Alternatively, it is possible to consider a nonstructural lip, made from a sandwich or monolithic composite material, associated with a structural partition according to the alternatives previously mentioned.

Advantageously, the structure comprises at least one transition zone between a portion made from a composite sandwich material and a portion made from a monolithic composite material, characterized in the transition is done by monolithic overlapping with multiaxial weaving.

It will also be noted that advantageously, the leading edge has a variable thickness along its profile, and in particular, for example, a greater thickness at the major curves and lesser at its ends.

The present invention also relates to an air intake, remarkable in that it comprises a leading edge structure according to the preceding.

The present invention also relates to a nacelle for an aircraft engine, remarkable in that it comprises an air intake according to the preceding.

### BRIEF DESCRIPTION OF THE DRAWINGS

Other features and advantages of the present invention will appear in light of the following description, and upon examination of the appended figures, in which:

FIG. 1 diagrammatically illustrates one half of an air intake of the prior art (see the preamble of this description) in longitudinal cross-section, and

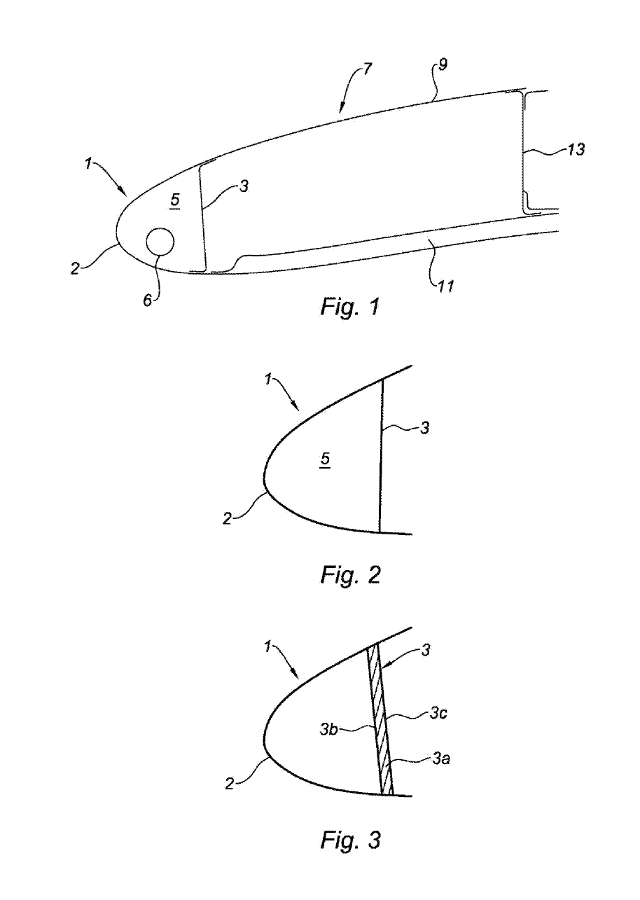

FIGS. 2 to 6 show five different embodiments of a leading edge structure according to the invention.

In all of these figures, identical or similar references designate identical or similar members or subsets of members.

### DETAILED DESCRIPTION

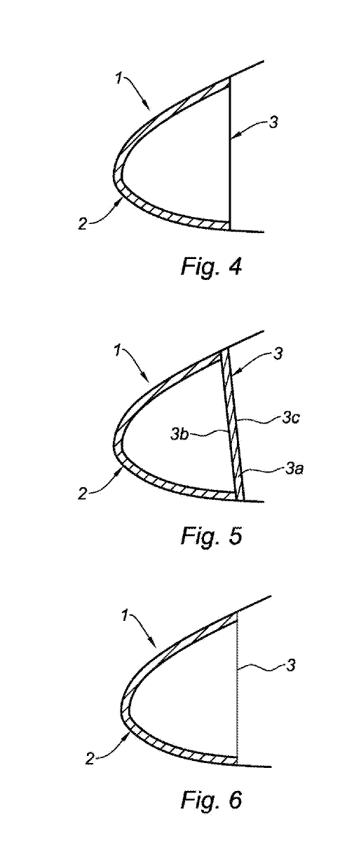

FIG. 2 shows a leading edge structure according to the invention, intended in particular to be incorporated into an air intake of an aircraft engine nacelle.

As in the leading edge structure of the prior art previously described, the structure according to the invention comprises a leading edge 2 strictly speaking, and an inner longitudinal partition wall 3 defining a compartment 5 intended in particular to receive deicing members (not shown).

Remarkably according to the invention, in this first embodiment, the leading edge 2 is structural and made from an axial monolithic composite material, and the inner partition 3 is structural and made from a multiaxial monolithic composite material.

As previously explained, this means that the leading edge 2 has a structural function, in addition to an aerodynamic function. The forces are also equally reacted by the inner partition wall 3, correctly dimensioned.

Alternatively, it will be noted that it is possible to provide a non-structural leading edge, then performing only an aerodynamic role, the majority of the forces being primarily reacted by the structural partition wall.

The leading edge 2 is formed by a superposition of one-dimensional (UD) and/or two-dimensional (2D) plies, connected to one another by fibers passing through their thicknesses, said fibers being placed by sewing, weaving or braiding.

The fibers positioned inside each ply as well as those making it possible to secure said plies to one another can for example be formed from glass, carbon or Kevlar.

The manufacturing method for such a multiaxial monolithic composite comprises dry-assembling the plies by sewing, weaving or braiding, then injecting resin into the assembly thus obtained, using an infusion technique known in itself or RTM (Resin Transfer Molding).

The inner partition wall 3 is made using the same method, and is dimensioned so as to be able to react the play forces.

The embodiment of FIG. 3 differs from the previous one in that the inner partition wall 3, which is also structural, is made from a multiaxial sandwich composite material.

This means that this inner partition wall 3 includes a core 3a sandwiched between two groups of plies 3b and 3c.

The core 3a can be manufactured from any material having an excellent strength/weight ratio, and in particular made from foam, or a honeycomb structure.

To manufacture this inner partition wall 3, according to a first alternative, multiaxial monolithic composite materials are chosen so as each to form two layers 3b and 3c, and these two layers are fastened on the core 3a, and lastly the assembly thus obtained is injected with resin, using an infusion method or RTM.

According to a second manufacturing alternative of said inner partition wall 3, stratified monolithic composite materials are chosen so as each to form two layers 3b and 3c, they are then fastened on either side of the core 3a, all of those elements are assembled by sewing, weaving or braiding, and lastly resin is injected into the assembly thus obtained, by infusion or RTM method.

In the embodiment of FIG. 4, it is the leading edge 2 that has a sandwich structure similar to that of the inner partition wall 3 of the embodiment of FIG. 3.

This leading edge is sized so as to ensure the rigidity and necessary strength of the leading edge structure 1.

It should be noted that the leading edge 2 can be locally multiaxial and monolithic.

In this embodiment of FIG. 4, the inner partition wall 3 is structural and monolithic, thereby contributing to excellent rigidity of the leading edge structure.

In the embodiment of FIG. 5, the leading edge structure 2 is identical to that of the leading edge structure of the embodiment of FIG. 4.

The structure of the inner partition wall 3 is identical to that of the inner partition wall of the embodiment of FIG. 3.

In that case, as in the previous one, both the leading edge and the inner partition perform a structural function, which contributes to the excellent rigidity of the leading edge structure.

In the embodiment of FIG. 6, the leading edge structure 2 is identical to that of the leading edges of FIGS. 4 and 5.

The inner partition wall 3 is formed from a multiaxial monolithic composite material, and does not perform a structural function: the sole purpose of this inner partition 3 is therefore to delimit the deicing compartment 5 relative to the rest of the air intake.

In this embodiment, the structural strength of the leading edge structure is therefore quasi-completely ensured by only the leading edge 2.

In other words, this means that, from a structural perspective, one could completely do away with the presence of the inner partition 3.

Advantageously, it will be noted that if the structure comprises at least one transition zone between a portion made from a composite sandwich material and a monolithic composite material portion, this transition will preferably be made by monolithic overlap with multiaxial weaving.

Of course, the present invention is in no way limited to the embodiments described above, and all other combinations of monolithic and sandwich multiaxial composite materials could be considered.

1. A leading edge structure for an aircraft nacelle air intake, comprising:
a leading edge and
an inner partition wall defining a longitudinal compartment within said leading edge,
wherein said leading edge and said inner partition wall are formed from multiaxial composite materials.

2. The structure according to claim 1, wherein said leading edge is structural and made from a multiaxial monolithic composite material, and said inner partition wall is structural and made from a multiaxial monolithic composite material.

3. The structure according to claim 1, wherein said leading edge is structural and made from a multiaxial monolithic composite material, and said inner partition wall is structural and made from a multiaxial sandwich composite material.

4. The structure according to claim 1, wherein said leading edge is structural and made from a multiaxial composite sandwich material, and said inner partition wall is structural and made from a multiaxial monolithic composite material.

5. The structure according to claim 1, wherein said leading edge is structural and made from a multiaxial sandwich composite material, and said inner partition wall is structural and made from a multiaxial sandwich composite material.

6. The structure according to claim 1, wherein said leading edge is structural and made from a multiaxial sandwich composite material, and said inner partition wall is non-structural and made from a multiaxial monolithic composite material.

7. The structure according to claim 1, wherein said leading edge is structural and made from a multiaxial sandwich composite material, and said inner partition wall is non-structural and made from a multiaxial sandwich composite material.

8. The structure according to claim 1, further comprising at least one transition zone between a portion made from a composite sandwich material and a portion made from a monolithic composite material, characterized in the transition is done by monolithic overlapping with multiaxial weaving.

9. The structure according to claim 1, wherein the leading edge has a variable thickness along its profile and a greater thickness at the major curves and lesser at its ends.

10. An air intake, comprising a leading edge structure according to claim 1.

11. A nacelle for an aircraft engine, comprising an air intake according to claim 8.
